(19) United States
(12) Patent Application Publication
(10) Pub. No.: US 2006/0097002 A1
(43) Pub. Date: May 11, 2006

(54) Gauze on stick (GOS)

(76) Inventor: Richard G. Chavez, El Paso, TX (US)

Correspondence Address: RICHARD GABRIEL CHAVEZ, RN BSN, 12425 PASEO DE ARCO COURT, EL PASO, TX, 79928, US

(21) Appl. No.: 10/983,821

(22) Filed: Nov. 8, 2004

(51) Int. Cl. B65G 59/00

(52) U.S. Cl. 221/251

(57) ABSTRACT

A device for the dispensing of gauzes and the like comprises a housing devise for mechanical dispensing of multiple disposable gauzes, a cap at the end of the dispensing device, and elements for the circular gauze to allow for sterility, grip and usefulness. The elements include a groove and bead head system that allow for dispensing of the circular gauzes that are secured in place by a master circular disk and spring with a system of opposing saw teeth to allow forward motion of the circular gauze disks and the actual disposable circular gauze disks with and absorbent material on one side and on the other side a latex or rubber belt to allow for securing of circular gauze disk over venipuncture site and a small circular absorbent pad with circular tape to place over a venipuncture site as needed.

### CROSS REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR COMPUTER PROGRAM LISTING COMPACT DISK APPENDIX

Not Applicable

### BACKGROUND OF THE INVENTION

The field of invention or technical field to which this invention pertains to is a medical device for use in phlebotomy.

At this time, there is to my knowledge no related subject matter pertaining to this invention. If any description of related art could be made, then latex gloves or face shields against biohazard contamination would fit this category. Yet, this device is one of the few that provide additional protection against accidental exposure with contaminated blood and needles. Each year, OSHA reports on the serious problems faced by health care workers when dealing with the state of technology or the art of drawing blood from patients in a safe and efficient manner and avoiding accidental needle sticks with potentially hazardous blood.

### BRIEF SUMMARY OF INVENTION

This invention known here-in as “Gauze on Stick” abbreviated as GOS, will greatly reduce the risk of acquiring a serious disease by health care workers such as doctors, nurses, and lab technicians by operating in the following manner: First, it will physically remove by approximately 3-4 inches the point of contact between a contaminated needle that is being withdrawn from a patient's vein and the health care's hand/arm (if used appropriately). This will be accomplished by eliminating the need to expose the health care worker's hand to close proximity to the exit point of a needle and vein when the needle is being drawn out and pressure is being applied with a standard gauze. This is the precise moment when needle stick accidents can occur, either by the patient involuntarily jerking arm forward and causing health care worker to stick self with needle or by health care worker not paying attention when removing needle from vein.

Second, the Gauze on Stick (GOS) will have at its distal point removable and disposable circular disks with an absorbent pad composed of cotton or another absorbent material that will be the collection vehicle of oozing blood from a vein after a venipuncture. A venipuncture is known as a phlebotomy procedure in which blood is collected from a vein with a needle and syringe. These circular gauze disks will be preferably sterile units that may be manufactured in different sizes and colors. These gauze disks will be housed in a dispensing case or unit made of a hard material, such as plastic. These circular shaped gauze disks will consist of a top and bottom side. The top side will house the absorbent material and on the bottom side two needed items; a latex strap that will serve, if needed, as a means to secure the circular gauze disk over a venipuncture site to provide needed pressure to stop bleeding, and also a small circular pad with adhesive tape that will serve as a removable circular band-aid that can be place over the venipuncture site.

Third, the Gauze on Stick (GOS) will have a removable cap that protects the circular gauze disks when not in use. The absorbent material may be covered with a removable thin protective layer if sterile environment is desired.

Fourth, the gauze disks will be stacked in bundles of 10-15 units and stored in the dispensing case or unit for their use and carrying. Advancing of the circular gauze disks will be accomplished by the constant pressure of the spring from the last disk at proximal end, and by the user with a simple pressing down action at the proximal end of dispensing unit. The dispensing case or unit will come in different sizes, colors and possible exterior designs to be used on adult and pediatric patients.

The advantages of the Gauze on Stick (GOS) are many. First and most important, it provides the user with added protection from accidental needle sticks. Second, it frees the user from having to hold manual hand pressure over a venipuncture site by using the latex belt instead to secure the circular gauze disk over the exit point of a needle and vein. Third, it provides a good means of collecting any blood leakage post venipuncture.

The object of the Gauze on Stick (GOS) is to decrease the incidence of needle sticks by health care workers when collecting blood samples from patients in hospitals, clinics, homes, ambulances, labs and any other situation that warrants collecting blood samples.

### DETAILED DESCRIPTION OF THE INVENTION

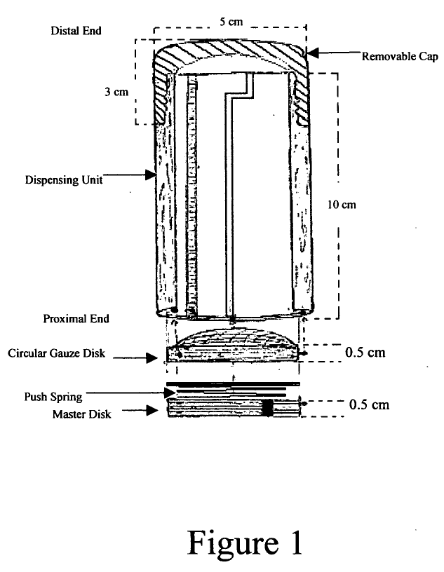

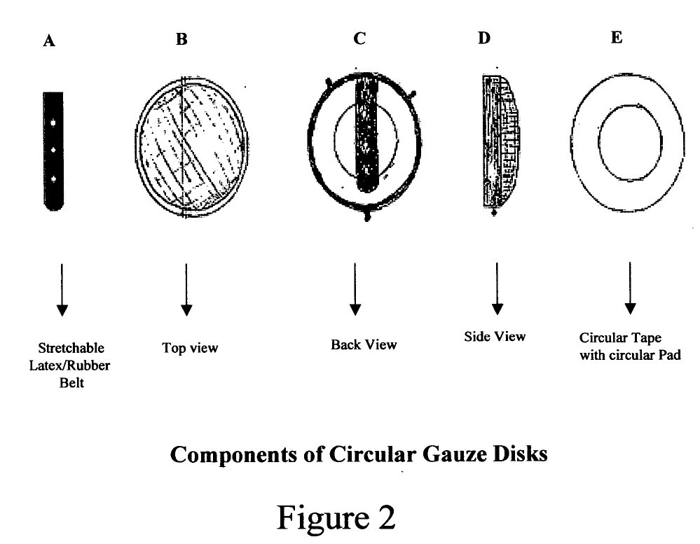

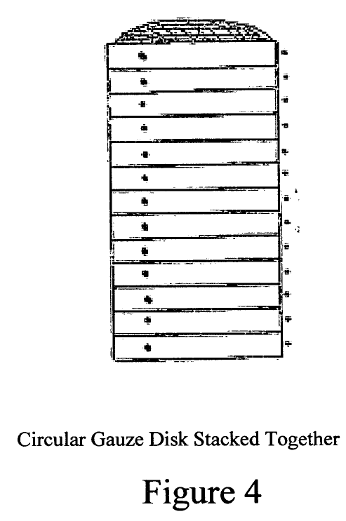

The Gauze on Stick (GOS) is a relatively simple, yet effective way in reducing the incidents of accidental needle sticks in the workplace when health care workers collect blood samples from patients. A full description is as follows: It shall basically consist of two parts, the circular gauze disks and the dispensing case or unit that houses them (FIG. 1). The circular gauze disk consists of 5 parts that include a thin covering over the gauze, the gauze itself, the plastic disk, the latex/rubber strap or belt, and the circular band-aid (FIG. 2). The top side of the disk shall contain the thin, removable plastic or paper sheath that covers the gauze and ensures a sterile content. The gauze will be made of cotton or another absorbent material with a hard supporting backing or disk, preferably made of a hard plastic (FIG. 2, B). The bottom side of the disk shall house two items: a circular tape and a circular absorbent pad to serve as a band-aid. Also, it will house a latex or rubber band anchored to the bottom side of the disk, with small holds on the middle that will serve to secure the band on various head beads on the disk (FIG. 2, C, E, A). The circular gauze disks will be stacked in 10-15 units and these will be housed in the dispensing unit (FIG. 4, 6).

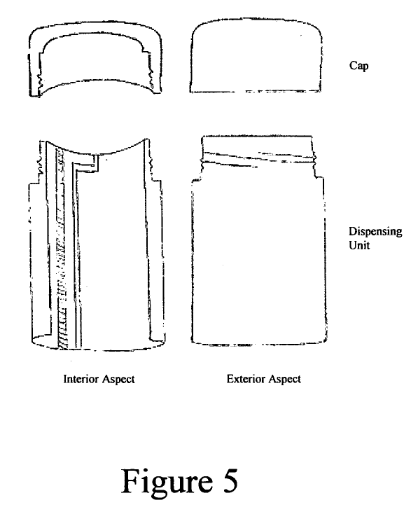

On the other hand, the dispensing unit consists of 3 parts that include the dispensing unit, the removable cap, and the master circular disk and spring at proximal end (FIG. 1). The cap is removed or replace by screwing it on or off and serves to protect the circular gauze disks that are housed within the dispensing unit when not in use (FIG. 5). Finally, the master circular disk at proximal end serves to secure and anchor the stack of 10-15 circular gauze disks in the dispensing unit (FIG. 1, 7).

The dispensing unit will come in two sizes, standard and small. Without the cap, the standard size will have the dimensions of, but not limited to: width 5 cm, length 10 cm, depth 5 cm (FIG. 1). The small size will be: width 2.5 cm, length 10 cm, and depth 2.5 cm. The idle material to manufacture the Gauze on Stick (GOS) will be a hard, smooth, disposable plastic of various colors.

The inner aspect of the dispenser will have a simple mechanism to guide and secure the stacked circular gauze disks (FIG. 1, 7). It shall have a system of grooves or canals etched inside the walls of the dispensing unit that guide the bead heads of the circular gauze disks straight down for dispensing. There shall be a minimum of three guidance grooves or canals to guide the circular gauze disks.

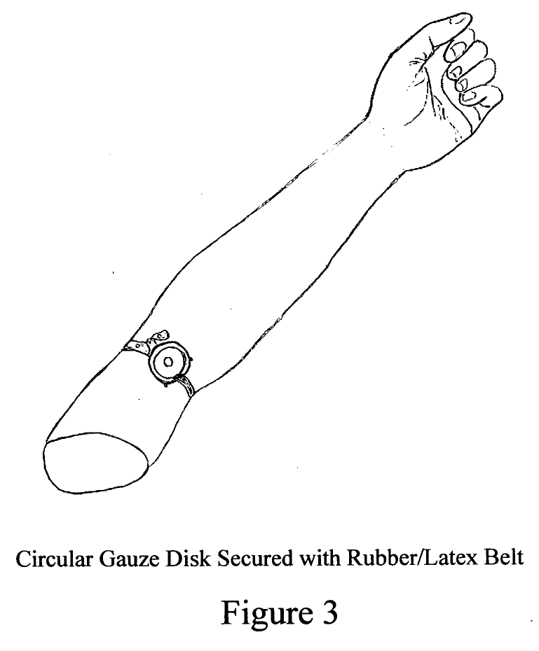

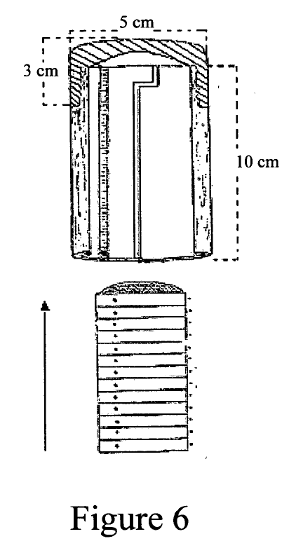

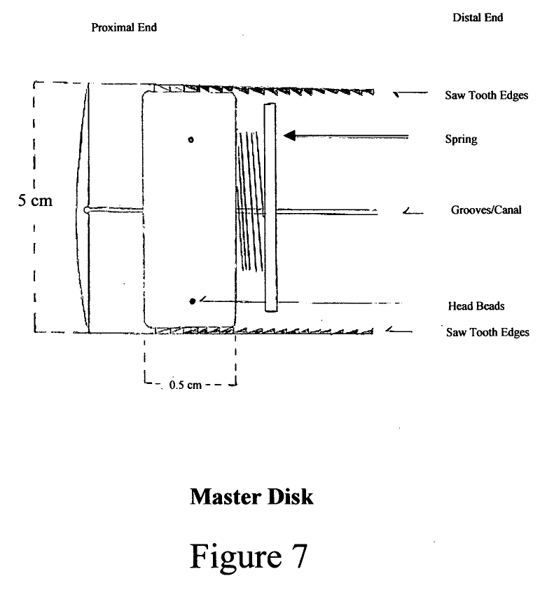

The inner aspect of the dispenser shall also have an anti-backward mechanism to ensure that the circular gauze disks move forward and not backward. This will be accomplished by having two rows of small saw tooth edges pointing toward dispensing point at distal end. The master circular disk at the end of the stack of circular gauze disks will have two points that will engage the two rows of small saw tooth edges by having also small saw tooth edges but pointing in the opposite directions toward the proximal end of the dispensing unit (FIG. 7). The forward motion needed to dispense the circular gauze disks will be accomplished by the constant pressure of the spring from the last disk at proximal end, and by simply pressing down on the master disk with the hand at the proximal end of the dispensing unit. The actual dispensing of the circular gauze disks will be possible by pressing down on circular gauze disk for traction and twisting it counter clockwise. This will be accomplished by a unique design of grooves and circular head beads. By having a special system of grooves and head beads that travel straight down and stopping 0.25 cm before reaching the end of the edge at the distal point of the dispensing unit, then turning and continuing 1 cm, then stopping and continuing 0.25 cm straight down till exit edge of dispensing unit (FIG. 6). Once the circular gauze disk is dispensed, it could be secured over the venipuncture site with the latex or rubber band (FIG. 3). The circular band-aid could then be used if needed over the venipuncture site and the circular gauze disk discarded.

This invention, the Gauze on Stick (GOS), will be manufactured by a process known as injection molding. Each part will be manufactured in hard, durable, disposable plastic. The parts then can be assembled by machine or hand to include the soft parts such as the circular gauze, band-aid and latex/rubber band. The assembled Gauze on Stick (GOS) could then be individually packaged in small plastic bags and irradiated if required to ensure sterile state of finished product. This is a new invention and building process. This is the description of the preferred embodiment.

What I claim as my invention is a device that houses multiple disposable gauzes that are mechanically dispensed:

1. Elements of my first claim consist of the dispensing mechanism that allows for an easy push and twist action to dispense gauze units.
My second claim as my invention is the circular gauze disks that are dispensed by the device.
The element of my second claim is the individual gauze units. Their design allow for quick and easy collection of blood, the latex/rubber band allows for tourniquet style application of pressure for venipuncture site and a useful tape and gauze to use as band aid.
My third claim as my invention is the stabilizing master circular disk.
The element of my third claim is the system of grooves, circular head beads and anti-backward mechanism with saw tooth edges that stabilizes and guides the circular gauze disks for dispensing from device.
